(19) United States
(12) Patent Application Publication
(10) Pub. No.: US 2024/0316806 A1
(43) Pub. Date: Sep. 26, 2024

(54) TRANSMISSION SYSTEM FOR USE IN A SHAVING HEAD OF AN ELECTRIC SHAVER

(71) Applicant: KONINKLIJKE PHILIPS N.V., EINDHOVEN (NL)

(72) Inventors: THOMAS SJOERD VAN DEN BERG, ENSCHEDE (NL); EELCO ARMINAK GALESTIEN, DRACHTEN (NL); MICHEL VAN ES, GRONINGEN (NL)

(21) Appl. No.: 18/574,387

(22) PCT Filed: Jun. 23, 2022
(86) PCT No.: PCT/EP2022/067188

§ 371 Date: Dec. 27, 2023

(30) Foreign Application Priority Data
Jun. 29, 2021 (EP) 21182346.3

(51) Int. Cl. B26B 19/14

(52) U.S. Cl. CPC B26B 19/146

(57) ABSTRACT

A transmission system (100) for use in an electric shaver comprises a first base portion (41), a second base portion (42), and a coupling arrangement (50) coupled to the respective base portions (41, 42) such as to convert a rotation of the first base portion (41) about a first rotation axis (Aᵣ₁) into a rotation of the second base portion (42) about a second rotation axis (Aᵣ₂). The coupling arrangement (50) comprises N coupling portions (51) which are each coupled to the respective base portions (41, 42), at least in a tangential direction relative to the respective rotation axis (Aᵣ₁, Aᵣ₂), wherein N is at least two. The coupling portions (51) are mutually coupled such that the coupling portions (51) are displaceable relative to each other only in an axial direction of a central axis (A_{c}) which extends through center points (B_{c1}, B_{c2}) of the respective base portions (41, 42).

### FIELD OF THE INVENTION

The invention relates to a transmission system, particularly a transmission system for use in a shaving head of an electric shaver. Further, the invention relates to a shaving head of an electric shaver, and also to an electric shaver comprising a body unit and a shaving head which is couplable or coupled to the body unit, wherein the body unit accommodates an actuator which is configured to actuate components of the transmission system in the coupled condition of the shaving head.

### BACKGROUND OF THE INVENTION

Electric shavers and shaving heads for use in electric shavers are generally known. Electric shavers are generally used to shave body hair, which may be facial hair, and are powered by electric supply mains and/or by electric energy storage devices such as batteries.

In a generally known set-up, a shaving head comprises an assembly of a support structure and a shaving unit, and further comprises at least one hair-cutting unit supported by the shaving unit. Traditionally, the hair-cutting unit comprises a combination of an external cutting member having a shaving surface provided with hair-entry openings as a non-driven component and an internal cutting member as a driven component, wherein at least the internal cutting member has one or more cutting edges. In such a case, use of the shaving head as incorporated in an electric shaver involves putting the shaving head to an operation mode in which the internal cutting member of the hair-cutting unit is actually moved, and moving the shaving head over the skin in such a way that the shaving surface of the external cutting member of the hair-cutting unit faces and contacts the skin. In the process, hairs protruding from the skin are caught in a space of the hair-cutting unit in which they are made to abut against the external cutting member at the position of a hair-entry opening and are cut through when they are encountered by a cutting edge of the internal cutting member.

In the shaving head of various known electric shavers, the shaving unit is arranged so as to be pivotable relative to the support structure about a pivot point to a certain extent, as a result of which the shaving unit is enabled to follow a contour of an area of skin to be shaved. Details of a known electric shaver which is representative in this respect are described in WO 2014/184065 A1, to mention one example of various disclosures of a pivoting arrangement of the shaving unit of the shaving head. It is an object of the invention to provide a transmission system that is suitable for use in a shaving head of an electric shaver, without hampering the functionality of contour following, particularly without hampering the pivoting movement of the shaving unit of the shaving head. In the context as mentioned, such a transmission system may be used for realizing a functionality of the shaving head that involves setting a position of an output component by setting a position of an input component which is not fixedly coupled to the output component. For example, it may be desirable to have a functionality of varying in an axial direction the relative position of the external cutting member and a skin supporting member having a skin supporting surface surrounding the external cutting member, as in that case, a user is enabled to influence the shaving performance of the electric shaver and the degree of skin irritation as a result of a shaving action according to personal preferences and/or in dependence of the characteristics of the skin and the hairs.

One difficulty that is relevant to the process of designing a shaving head so as to include a transmission system is that space in the shaving head is very much limited. Also, the space that would be ideal to use is already occupied by the drive train of the internal cutting unit. Yet another difficulty resides in the desire to maintain the functionality of contour following, as already suggested in the foregoing. For example, when the option of using a pin-slot guidance construction in the transmission system is considered, it is found that the pivoting movement causes the pin to be pressed against an internal wall of the slot with force. This might be counteracted by introducing play in the pin-slot guidance construction, but doing so reduces the accuracy of the transmission system and is therefore not practical.

### SUMMARY OF THE INVENTION

The invention provides a transmission system comprising:
a main housing;
a first base portion which is rotatable relative to the main housing about a first rotation axis which is stationary relative to the main housing;
a second base portion which is rotatable about a second rotation axis and pivotal about a pivot point which is stationary relative to the main housing, the second rotation axis maintaining a stationary orientation relative to the second base portion during pivoting of the second base portion about the pivot point;
a coupling arrangement coupled to the first base portion and to the second base portion such as to convert a rotation of the first base portion about the first rotation axis into a rotation of the second base portion about the second rotation axis;
   wherein:
the coupling arrangement comprises N coupling portions which are each coupled to the first base portion, at least in a tangential direction relative to the first rotation axis, in a respective one of N first coupling positions on the first base portion, and which are each coupled to the second base portion, at least in a tangential direction relative to the second rotation axis, in a respective one of N second coupling positions on the second base portion, wherein N is at least two;
the N first coupling positions have equal axial positions in a direction parallel to the first rotation axis, a first center point of the first base portion being located on the first rotation axis in a position corresponding to said axial positions of the N first coupling positions;
the N second coupling positions have equal axial positions in a direction parallel to the second rotation axis, a second center point of the second base portion being located on the second rotation axis in a position corresponding to said axial positions of the N second coupling positions;
a central axis of the coupling arrangement extends through the first and second center points; and
the coupling portions are mutually coupled such that the coupling portions are displaceable relative to each other only in an axial direction of the central axis.

On the basis of the configuration of the coupling arrangement defined in the foregoing, it is achieved that the coupling arrangement is enabled to perform the functionality of converting a rotation of the first base portion about the first rotation axis into a rotation of the second base portion about the second rotation axis under all circumstances including a situation of a pivoted position of the second base portion, i.e. a position which differs from a position in which the second rotation axis has the same orientation as the first rotation axis. The coupling portions are each coupled to both the first base portion and the second base portion, at least in a tangential direction relative to the respective rotation axes of the base portions, wherein a central axis of the coupling arrangement always extends through respective center points of the base portions. Various options in respect of the orientation of the central axis, which are directly related to various options in respect of the position of the second base portion relative to the pivot point, are feasible in view of the fact that the relative position of the coupling portions in the axial direction of the central axis is adjustable. Thus, the coupling arrangement is free to follow movements of the second base portion, while a position of the coupling arrangement in a tangential direction about the central axis is determined by the position of the first base portion.

The coupling arrangement is capable of transmitting forces in the tangential direction about the central axis, on the basis of which torque can be transmitted from the first base portion to the second base portion. Transmittal of forces in the axial direction of the central axis cannot take place. The coupling portions can be designed and arranged such that a generally ring-like appearance of the coupling arrangement is realized, which offers an interesting possibility of incorporating the coupling arrangement in an existing design involving one or more drive train components such as a drive shaft, because the coupling portions can be arranged around such drive train components.

As defined in the foregoing, the pivot point about which the second base portion is pivotable is stationary relative to the main housing of the transmission system. Also, the first rotation axis about which the first base portion is rotatable relative to the main housing is stationary relative to the main housing. In a practical embodiment of the transmission system according to the invention, the first rotation axis and the second rotation axis extend both through the pivot point. Among other things, this implies that the second rotation axis of the second base portion coincides with the first rotation axis of the first base portion when the second base portion is in a neutral, non-pivoted position and the second rotation axis has the same orientation as the first rotation axis.

In respect of the pivot point, it is noted that it may particularly be so that the pivot point is positioned outside of the transmission system at the side of the second base portion, i.e. that the pivot point is arranged at a distance from an imaginary surface extending through the second center point perpendicularly to the second rotational axis, wherein said imaginary surface is located between the pivot point and the first center point.

In respect of the number N of the coupling portions, it is noted that it is advantageous if N is at least three. In general, the higher the number N, the less adjacent coupling portions need to displace in the axial direction of the central axis relative to each other, and the less displacement length is needed in the transmission system. Hence, it is possible to design the transmission system with a reduced length by choosing a higher number N of the coupling portions. Choosing the number N to be three yields a stable construction in view of the fact that there are three coupling positions per base portion in that case, but that does not alter the fact that choosing a higher value in respect of N is also possible.

Further, it is advantageous if the N coupling portions are arranged at mutually identical angular intervals of 360°/N around the central axis, because that also contributes to stability of the construction in view of an even distribution of forces among the coupling portions. For similar reasons, it may be practical if the N coupling portions are mutually identical.

Advantageously, for the purpose of enabling the co-linear displacement of the coupling portions in the axial direction of the central axis, the coupling portions of each pair of adjacent coupling portions are mutually coupled by means of a guiding structure that allows the coupling portions of the pair to mutually slide in the axial direction of the central axis. For example, it may be so that each of the side portions of each of the coupling portions is slidably engaged to a side portion of an adjacent coupling portion. In this respect, it is noted that an embodiment of the transmission system is feasible in which, at a coupling interface of two adjacent coupling portions, the side portion of the one coupling portion comprises a thickened edge and the side portion of the other coupling portion comprises a hollow edge which partially encompasses the thickened edge of the one coupling portion.

In general, also for the purpose of enabling the co-linear displacement of the coupling portions in the axial direction of the central axis, it is practical if the coupling portions are each, in the respective first coupling position, displaceably guided relative to the first base portion in the direction parallel to the central axis, and/or if the coupling portions are each, in the respective second coupling position, displaceably guided relative to the second base portion in the direction parallel to the central axis. For example, it is possible that the coupling portions are each, in the respective first coupling position, coupled to the first base portion by means of a pin-slot connection comprising a pin mounted to the first base portion in the respective first coupling position and engaging a slot provided in the respective coupling portion and extending parallel to the central axis, and/or if the coupling portions are each, in the respective second coupling position, coupled to the second base portion by means of a pin-slot connection comprising a pin mounted to the second base portion in the respective second coupling position and engaging a slot provided in the respective coupling portion and extending parallel to the central axis. It is possible that the slot of the pin-slot connection through which the coupling portions are each, in the respective first coupling position, coupled to the first base portion, is open as seen in the axial direction of the central axis, at a side of the slot facing away from the second coupling position, as the axial displacement of each of the coupling portions is dictated by the second base portion without a need for limitation of the axial displacement at the position of the first base portion.

It may be practical if a gear wheel is connected to the second base portion at a side of the second base portion facing away from the coupling arrangement, wherein a gear axis of the gear wheel coincides with the second rotation axis, because such a gear wheel can be used to drive, particularly determine the setting of, one or more components on the basis of a rotation of the second base portion about the second rotation axis induced by a rotation of the first base portion about the first rotation axis.

The invention also relates to a shaving head of an electric shaver, comprising:
a support structure;
a shaving unit supporting at least two hair-cutting units which each have an external cutting member and an internal cutting member which is rotatable relative to the external cutting member; and
a transmission system as described here before;

wherein:
the main housing of the transmission system is arranged in a stationary position relative to the support structure;
the shaving unit, together with the hair-cutting units, is arranged to be allowed to assume pivoted positions relative to the support structure about a pivot point corresponding to the pivot point of the transmission system;
the first base portion of the transmission system is rotationally supported relative to the support structure of the shaving head; and
the second base portion of the transmission system is rotationally supported relative to the shaving unit of the shaving head.

By applying the transmission system in the shaving head as defined, it is achieved that a rotation of the first base portion about the first rotation axis can always be converted into a rotation of the second base portion about the second rotation axis, regardless of the position of the shaving unit relative to the pivot point.

As mentioned earlier, it is possible that the coupling portions are designed and arranged such that a generally ring-like appearance of the coupling arrangement is realized. In view thereof, it is possible to have an embodiment of the shaving head which further comprises a central drive shaft arranged in the support structure and a primary gearing system arranged in the shaving unit to convert a rotation of the central drive shaft into rotations of the internal cutting members of the respective hair-cutting units, and to have an arrangement of the coupling portions of the coupling arrangement of the transmission system around the central drive shaft. In that way, the transmission system can be integrated in the shaving head in a very compact fashion.

The rotation of the second base portion about the second rotation axis as determined by the rotation of the first base portion about the first rotation axis can be put to use in any way as desired. For example, it is possible that the shaving head according to the invention comprises:
for each of the hair cutting units, a movable adjustment member;
a secondary gearing system arranged in the shaving unit to convert a rotation of the second base portion of the transmission system into movement of the adjustment member of each of the hair-cutting units.

An example of a movable adjustment member of a hair-cutting unit is a member which is displaceable to vary in an axial direction the relative position of the external cutting member and a skin supporting member having a skin supporting surface surrounding the external cutting member. In general, it may be so that in each of the hair-cutting units, the movable adjustment member is arranged to actuate a mechanism configured to adjust an operational parameter of the respective hair-cutting unit. In the case that the transmission system comprises a gear wheel connected to the second base portion, it may be so that the gear wheel has a central position in the secondary gearing system.

The invention also relates to an electric shaver comprising a body unit and a shaving head as described here before, wherein the shaving head is couplable or coupled to the body unit, and wherein the body unit accommodates an actuator which is configured to rotate the first base portion of the transmission system in the coupled condition of the shaving head.

The above-described and other aspects of the invention will be apparent from and elucidated with reference to the following detailed description of a number of embodiments of a shaving head for use in an electric shaver.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a perspective view of an electric shaver according to an embodiment of the invention, which electric shaver comprises a shaving head and a body unit,

FIG. 2 diagrammatically shows a perspective view of an external cutting member, a decorative cap and an internal cutting member of a hair-cutting unit of the shaving head, wherein both the external cutting member and the cap are shown with a portion cut away,

FIG. 3 diagrammatically shows a perspective view of an assembly of components of a shaving head according to a first embodiment of the invention, including a transmission system according to a first embodiment of the invention,

FIG. 4 diagrammatically shows a perspective view of a first base portion of the transmission system,

FIG. 5 diagrammatically shows a perspective view of a second base portion of the transmission system as engaging on a gearing system including one gear per hair-cutting unit of the shaving head,

FIG. 6 diagrammatically shows a perspective view of an assembly of coupling portions of a coupling arrangement of the transmission system,

FIG. 7 illustrates how the coupling portions are movable and how the coupling portions are arranged about a central axis and relative to a first center point of the first base portion and a second center point of the second base portion,

FIG. 8 diagrammatically shows a perspective view of an assembly of components of a shaving head according to a second embodiment of the invention, including a transmission system according to a second embodiment of the invention,

FIG. 9 diagrammatically shows a perspective view of a portion of the shaving head including the second base portion of the transmission system,

FIG. 10 diagrammatically shows a perspective view of a portion of the shaving head including the first base portion of the transmission system, and

FIG. 11 diagrammatically shows a perspective view of an assembly of coupling portions of the coupling arrangement of the transmission system.

### DETAILED DESCRIPTION OF THE EMBODIMENTS

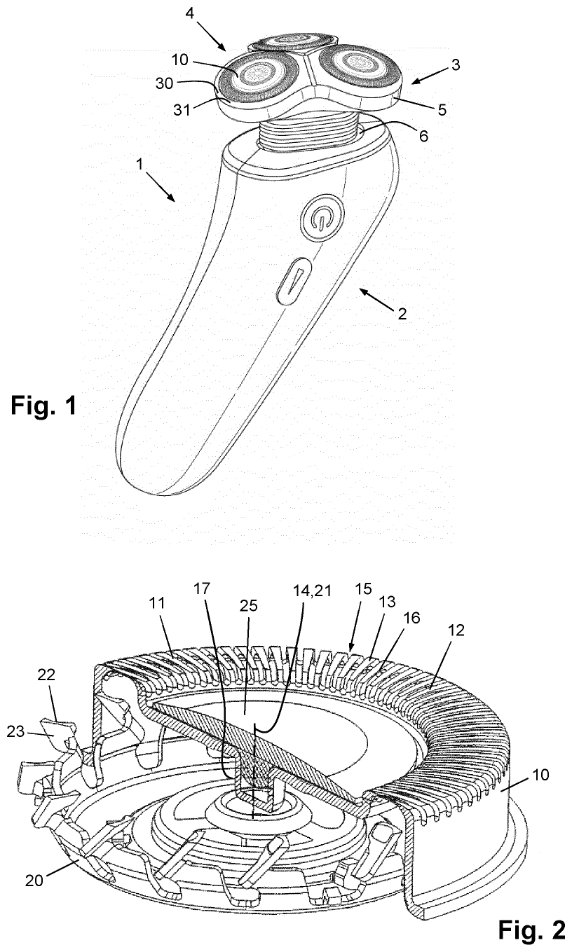

FIG. 1 shows an electric shaver of the rotary type, which is suitable to be used for shaving a beard, as a practical example of an electric shaver 1 according to an embodiment of the invention. The electric shaver 1 comprises a body unit 2 and a shaving head 3, wherein the body unit 2 is designed to enable a user of the electric shaver 1 to take hold of the electric shaver 1 and to handle the electric shaver 1, and wherein the shaving head 3 is the part of the electric shaver 1 that is to be positioned on and moved over the skin for hair removal. In the shown example, the shaving head 3 comprises three hair-cutting units 4 supported on a shaving unit 5 of the shaving head 3. When the electric shaver 1 is actually applied for the purpose of performing a shaving action, the actual process of cutting of hairs protruding from the skin takes place at the position of the hair-cutting units 4.

Each of the hair-cutting units 4 comprises a combination of an external cutting member 10 and an internal cutting member 20, as will now be described in more detail with reference to FIG. 2. The external cutting member 10 is of a generally cup-shaped design and is thereby suitable for at least partially accommodating the internal cutting member 20 in its interior. At an exterior side thereof, the external cutting member 10 has a shaving surface 11 configured to face the skin to be subjected to a shaving action. Further, an annular hair-cutting track 12 is present in the external cutting member 10, which hair-cutting track 12 comprises lamellae 13 extending along the width of the hair-cutting track 12, in a substantially radial direction relative to a longitudinal axis 14 of the external cutting member 10, which coincides with a rotational axis 21 about which the internal cutting member 20 is rotatable relative to the external cutting member 10. Apertures as present between the lamellae 13 constitute hair-entry openings 15 of the hair-cutting track 12. Sides of the lamellae 13 constitute hair-cutting surfaces 16 suitable for cutting off hairs in cooperation with hair-cutting edges 22 of hair-cutting elements 23 of the internal cutting member 20. The invention also relates to cases in which the hair-cutting track 12 does not comprise lamellae 13 or does not only comprise lamellae 13, such as cases in which the entire hair-cutting track 12 is provided with teeth-like elements and/or a pattern of (circular) holes instead of or in addition to lamellae 13. Also, the invention relates to cases in which more than one hair-cutting track 12 is present in the external cutting member 10.

A hair-cutting action can be performed when the internal cutting member 20 is activated to rotate and a portion of skin is actually contacted by the external cutting member 10 at the position of the hair-cutting track 12. Activation of the internal cutting member 20 may take place in a known manner by means of a drive mechanism of the electric shaver 1. When the combination of the external cutting member 10 and the internal cutting member 20 is moved over the portion of skin while the internal cutting member 20 is driven to rotate, it is achieved that hairs protruding from the portion of skin are caught in the hair-entry openings 15 of the hair-cutting track 12 of the external cutting member 10 and are cut off in that position as result of a cooperation between the hair-cutting surfaces 16 of the hair-cutting track 12 of the external cutting member 10 and the hair-cutting edges 22 of the hair-cutting elements 23 of the rotating internal cutting member 20.

Besides the hair-cutting track 12, the external cutting member 10 includes a central portion 17 comprising a central bearing portion which is designed to be used in rotationally supporting the internal cutting member 20 in the hair-cutting unit 4. The central portion 17 of the external cutting member 10 also serves for supporting a decorative cap 25 configured to cover part of the exterior surface of the external cutting member 10. In the shown example, the central portion 17 comprises a centrally located recess, and the cap 25 comprises a projection which is accommodated in the recess.

Each of the hair-cutting units 4 further comprises a skin supporting member 30. The skin supporting member 30 has a skin supporting surface 31 surrounding the external cutting member 10. The shaving unit 5 of the shaving head 3 is arranged so as to be pivotable relative to a support structure 6 of the shaving head 3 about a pivot point to a certain extent, the support structure 6 of the shaving head 3 being a portion of the shaving head 3 which is stationary relative to the body unit 2 and through which the shaving head 3 is coupled to the body unit 2 in the operational, assembled condition of the electric shaver 1. As a result of the pivotal arrangement as mentioned, the shaving unit 5 has a contour following functionality. For the sake of clarity, it is noted that most of the support structure 6 is not visible in FIG. 1 as a result of being received in a space in the body unit 2.

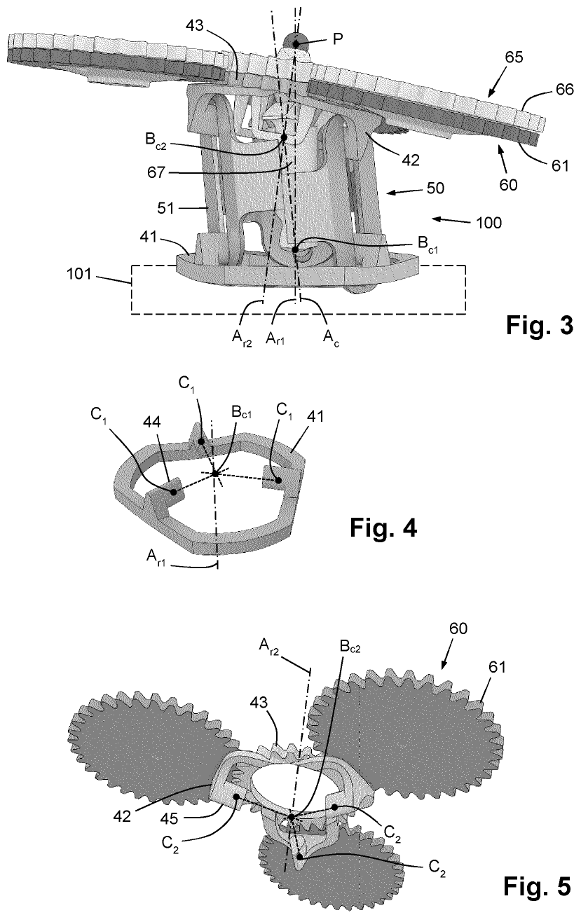

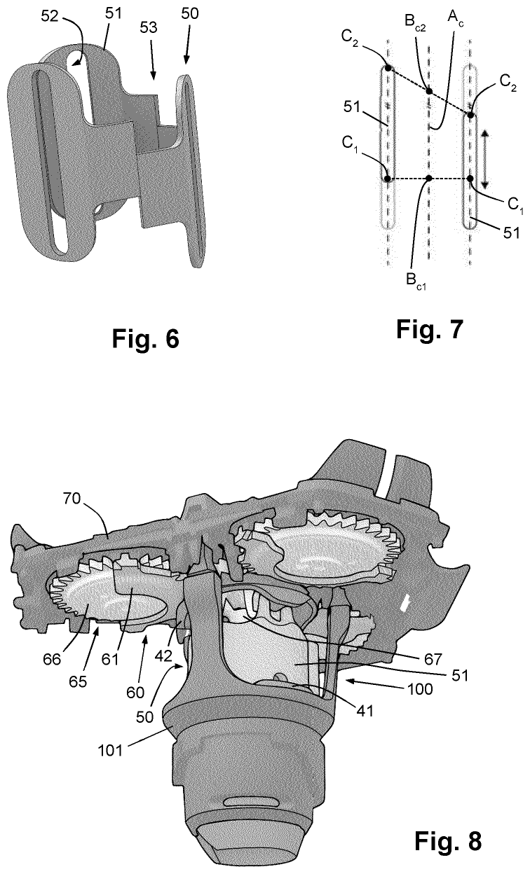

FIG. 3 shows an assembly of components of a shaving head 3 according to a first embodiment of the invention, including a transmission system 100 according to a first embodiment of the invention. A number of components of the transmission system 100 are shown separately in FIGS. 4, 5 and 6. The transmission system 100 comprises a first base portion 41, a second base portion 42 and a coupling arrangement 50 coupled to the first base 41 portion and to the second base portion 42. The first base portion 41 is rotatable relative to a main housing of the transmission system 100, which is diagrammatically indicated in FIG. 3 by means of dashed lines and indicated by means of reference numeral 101, and which is stationary relative to the support structure 6 of the shaving head 3. In particular, the first base portion 41 is rotatable relative to the main housing 101 about a first rotation axis Aᵣ₁ which is stationary relative to the main housing 101. The second base portion 42 is rotatable about a second rotation axis Aᵣ₂ and pivotal about a pivot point P which is stationary relative to the main housing 101 and which is the same as the pivot point of the pivoting movement of the shaving unit 5 of the shaving head 3. The second rotation axis Aᵣ₂ maintains a stationary orientation relative to the second base portion 42 during pivoting of the second base portion 42 about the pivot point P. Thus, the orientation of the second rotation axis Aᵣ₂ is the same as the orientation of the first rotation axis Aᵣ₁ when the second base portion 42 is in a non-pivoted position, and only the orientation of the second rotation axis Aᵣ₂ changes along with a pivoting movement of the second base portion 42. Further, in the present embodiment of the transmission system 100, the first rotation axis Aᵣ₁ and the second rotation axis Aᵣ₂ extend both through the pivot point P. The first base portion 41 functions as an input component of the transmission system 100, the second base portion 42 functions as an output component of the transmission system 100, and the coupling arrangement 50 serves to convert a rotation of the first base portion 41 about the first rotation axis Aᵣ₁ into a rotation of the second base portion 42 about the second rotation axis Aᵣ₂.

In the present embodiment of the transmission system 100, the transmission system 100 is used to drive a gearing system 60 including one gear 61 per hair-cutting unit 4 of the shaving head 3. A gear wheel 43 is connected to the second base portion 42 at a side of the second base portion 42 facing away from the coupling arrangement 50, wherein a gear axis of the gear wheel 43 coincides with the second rotation axis Aᵣ₂. It is through this gear wheel 43 that the second base portion 42 engages on the respective gears 61 of the gearing system 60, as can be seen in more detail in FIG. 5. In the present embodiment of the shaving head 3, each of the hair-cutting units 4 comprises a movable adjustment member (not shown in FIGS. 3, 4, 5 and 6), and the gearing system 60 is a secondary gearing system which is arranged in the shaving unit 5 of the shaving head 3 to drive the respective adjustment members by converting a rotation of the second base portion 42 into movement of the respective adjustment members. In each of the hair-cutting units 4, the movable adjustment member serves to actuate a mechanism configured to adjust an operational parameter of the respective hair-cutting unit 4, such as a mechanism configured to adjust in an axial direction the relative position of the external cutting member 10 and the skin supporting member 30. An advantage of having such a mechanism is that a user is allowed to personalize the shaving experience as far as the balance of closeness and comfort is concerned.

Besides the secondary gearing system 60, the shaving head 3 comprises a primary gearing system 65 including gears 66 configured to drive the internal cutting member 20 of the respective hair-cutting units 4, wherein rotation of the gears 66 is brought about by rotation of a central drive shaft 67. All of the second base portion 42 of the transmission system 100, the gears 61 of the secondary gearing system 60 and the gears 66 of the primary gearing system 65 are arranged so as to be pivotable together with the shaving unit 5 of the shaving head 3. The pivoting movement of the shaving unit 5 about the pivot point P is normally induced as a result of contact of the external cutting member 10 and the skin supporting member 30 of the respective hair-cutting units 4 to an area of skin to be shaved during actual use of the electric shaver 1, at the position of the shaving surface 11 and the skin supporting surface 31, respectively. FIG. 3 illustrates a pivoted position of the second base portion 42 and the respective gears 61, 66 of about 10° relative to the non-pivoted position.

As mentioned in the foregoing, the coupling arrangement 50 of the transmission system 100 is coupled to the first base portion 41 and to the second base portion 42 such as to convert a rotation of the first base portion 41 about the first rotation axis Aᵣ₁ into a rotation of the second base portion 42 about the second rotation axis Aᵣ₂. A special feature of the coupling arrangement 50 is that the coupling arrangement 50 is designed to function under all circumstances including a situation of a pivoted position of the second base portion 42. The fact is that the coupling arrangement 50 comprises a number of coupling portions 51, the number being three in the present embodiment of the transmission system 100, and that the configuration of the coupling portions 51 is in conformity with the following criteria:
each of the coupling portions 51 is coupled to the first base portion 41, at least in a tangential direction relative to the first rotation axis Aᵣ₁, in a first coupling position C₁ on the first base portion 41;
each of the coupling portions 51 is coupled to the second base portion 42, at least in a tangential direction relative to the second rotation axis Aᵣ₂, in a second coupling position C₂ on the second base portion 42;
the respective first coupling positions C₁ have equal axial positions in a direction parallel to the first rotation axis Aᵣ₁, a first center point B₁ of the first base portion 41 being located on the first rotation axis Aᵣ₁ in a position corresponding to said axial positions of the respective first coupling positions C₁;
the respective second coupling positions C₂ have equal axial positions in a direction parallel to the second rotation axis Aᵣ₂, a second center point B_{c2} of the second base portion 42 being located on the second rotation axis Aᵣ₂ in a position corresponding to said axial positions of the respective second coupling positions C₂;
a central axis A_{c} of the coupling arrangement 50 extends through the first and second center points B_{c1}, B_{c2}; and
the coupling portions 51 are mutually coupled such that the coupling portions 51 are displaceable relative to each other only in an axial direction of the central axis A_{c}.

The first and second center points B_{c1}, B_{c2}, two of the three first coupling positions C₁, two of the three second coupling positions C₂, and the central axis A_{c} are indicated in FIG. 7, in which further two coupling portions 51 are diagrammatically shown, and in which the axial direction of the central axis A_{c} is indicated by means of a double-headed arrow. The first and second center points B_{c1}, B_{c2} and the central axis A_{c} are also indicated in FIG. 3. It can clearly be seen that the central axis A_{c} intersects with the first rotation axis Aᵣ₁ at the position of the first center point B_{c1}, and that the central axis A_{c} intersects with the second rotation axis Aᵣ₂ at the position of the second center point B_{c2}. The above-mentioned fact that the first center point B_{c1} of the first base portion 41 is located on the first rotation axis Aᵣ₁ in a position corresponding to the axial positions of the respective first coupling positions C₁ can be seen in FIG. 4, while the above-mentioned fact that the second center point B_{c2} of the second base portion 42 is located on the second rotation axis Aᵣ₂ in a position corresponding to the axial positions of the respective second coupling positions C₂ can be seen in FIG. 5.

In the present embodiment, the coupling portions 51 include a slot 52 which is elongated in the axial direction. The first base portion 41 comprises pins 44 which extend inwardly through the slot 52 in a radial direction relative to the axial direction. Similarly, the second base portion 42 comprises pins 45 which extend inwardly through the slot 52 in the radial direction. Thus, pin-slot connections are realized at the respective first coupling positions C₁ and second coupling positions C₂, wherein movement of the respective pins 44, 45 in the respective slots 52 are only possible in the axial direction of the central axis A_{c}. The functionality of the transmission system 100 to convert a rotation of the first base portion 41 about the first rotation axis Aᵣ₁ into a rotation of the second base portion 42 about the second rotation axis Aᵣ₂ is realized on the basis of the fact that each of the pins 44 of the first base portion 41 is directly associated with a pin 45 of the second base portion 42 which extends through the same coupling portion 51 at the position of the slot 52 of the coupling portion 51. The capability of the transmission system 100 to perform the functionality not only when the second base portion 42 is in a non-pivoted position but also when the second base portion 42 is in a pivoted position is realized on the basis of the fact that the coupling portions 51 are mutually coupled such that the coupling portions 51 are displaceable relative to each other only in the axial direction of the central axis A_{c}. In particular, in the present embodiment, the coupling portions 51 of each pair of adjacent coupling portions 51 are mutually coupled by means of a guiding structure 53 that allows the coupling portions 51 of the pair to mutually slide in the axial direction of the central axis A_{c}.

By controlling the position of the first base portion 41 about the first rotation axis Aᵣ₁, it is eventually achieved that the position of the second base portion 42 about the second rotation axis Aᵣ₂ is set. In this way, as explained earlier, the setting of the secondary gearing system 60 is determined, and thereby the setting of the mechanism driven by the secondary gearing system 60 as a desired end result. In conformity with what is known in the art, the electric shaver 1 may be equipped with a controller and a user interface for receiving user input. According to the invention, the user input includes input which determines the setting of the mechanism driven by the secondary gearing system 60. If at a certain point the setting of the mechanism deviates from a setting desired by a user, the controller acts to put the first base portion 41 in motion until the latter setting is realized through associated movement of the second base portion 42 and the gears 61 of the secondary gearing system 60. This is done irrespective of the position of the second base portion 42 about the pivot point P, and this is done without influencing the way in which the internal cutting member 20 of the respective hair-cutting units 4 is driven, wherein it is to be noted that the coupling portions 51 of the coupling arrangement 50 extending between the first base portion 41 and the second base portion 42 are arranged around the central drive shaft 67. The body unit 2 of the electric shaver 1 may accommodate an appropriate actuator which is configured to realize movement of the first base portion 41 about the first rotation axis Aᵣ₁ when the body unit 2 and the shaving head 3 are coupled to each other. Such an actuator may include one or more gears, for example.

In respect of the user interface, it is noted that this may be a button, touch screen or the like on the body unit 2 of the electric shaver 1, but that other possibilities are covered by the invention as well, including a possibility of a button, touch screen or the like being present on a charging cradle or cleaning station of the electric shaver 1 in the case that the electric shaver 1 comes with such additional equipment, and a possibility of a smartphone having an appropriate app installed thereon being used by a user to exchange data with the controller of the electric shaver 1 in a remote and wireless fashion.

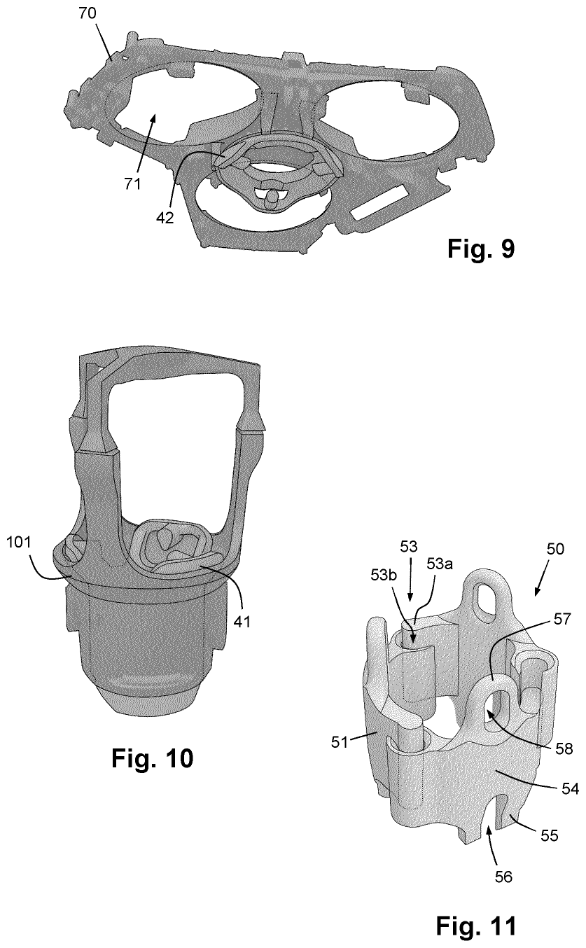

FIG. 8 shows an assembly of components of a shaving head 3 according to a second embodiment of the invention, including a transmission system 100 according to a second embodiment of the invention. A number of components of the transmission system 100 are shown separately in FIGS. 9, 10 and 11. The basic set-up of the transmission system 100 according to the second embodiment of the invention is comparable to that of the transmission system 100 according to the first embodiment of the invention. The transmission system 100 according to the second embodiment of the invention also comprises a first base portion 41, a second base portion 42 and a coupling arrangement 50 including coupling portions 51 which are slidable relative to each other in the axial direction of the central axis A_{c} of the coupling arrangement 50. In FIG. 9, a portion of the shaving head 3 including the second base portion 42 is shown, and in FIG. 10, a portion of the shaving head 3 including the first base portion 41 is shown. The portion of the shaving head 3 including the second base portion 42 is part of the shaving unit 5 of the shaving head 3 and includes a frame 70 having three openings 71 leaving space for a coupling of the internal cutting member 20 to the respective gear 66 of the primary gearing system 65 for driving the internal cutting member 20 in each of the hair-cutting units 4. The second base portion 42 is held in the frame 70 in a suitable way, such as on the basis of a snap connection. The portion of the shaving head 3 including the first base portion 41 is part of the support structure 6 of the shaving head 3, wherein the first base portion 41 is rotatable arranged in the portion about the first rotation axis Aᵣ₁.

In FIGS. 8 and 11, it can be seen that in the transmission system 100 according to the second embodiment of the invention, the design of the coupling portions 51 of the coupling arrangement 50 is different from the design of the coupling portion 51 in the transmission system 100 according to the first embodiment of the invention. Instead of being provided with a single elongated slot 52, each of the coupling portions 51 comprises an intermediate closed body 54, a U-shaped coupling member 55 defining an open slot 56 for interacting with a respective pin 44 of the first base member 41, and an eye-shaped coupling member 57 defining a closed slot 58 for interacting with a respective pin 45 of the second base member 42. In FIG. 11, it can be clearly seen that the guiding structure 53 is a structure in which, at a coupling interface of two adjacent coupling portions 51, the side portion of the one coupling portion 51 comprises a thickened edge 53a and the side portion of the other coupling portion 51 comprises a hollow edge 53a which partially encompasses the thickened edge 53b of the one coupling portion 51.

In a similar fashion as is the case in the transmission system 100 according to the first embodiment of the invention, the functionality to convert a rotation of the first base portion 41 about the first rotation axis Aᵣ₁ into a rotation of the second base portion 42 about the second rotation axis Aᵣ₂ is preserved for all possible positions of the second base portion 42, i.e. for both the non-pivoted position of the second base portion 42 and all possible pivoted positions of the second base portion 42. A setting of a mechanism driven by a secondary gearing system 60 of the shaving head 3 as appropriate in view of desires of a user can be realized under all circumstances without interfering with a primary gearing system 65 which functions to drive the internal cutting member 20 of the respective hair-cutting units 4 of the shaving head 3. As can be seen in FIG. 8, the gears 61 of the secondary gearing system 60 do not need to be designed as entire wheels but may be designed as wheel portions instead.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise.

Thus, the mere fact that certain measures are recited in mutually different dependent claims does not indicate that a combination of these measures cannot be used to advantage.

The terms “comprise” and “include” as used in this text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

In the present text, an action of hair removal from skin is generally referred to as shaving action, and this is at the basis of the use of terms such as “shaving head” and “electric shaver”. It is to be noted that the present choice for the shaving terminology should not be understood so as to restrict the invention in any way. Hence, the invention just as well covers hair removal units and devices which may normally be denoted by other terms in the relevant field.

Notable aspects of the invention are summarized as follows. A transmission system 100 is suitable for use in an electric shaver 1 and comprises a first base portion 41, a second base portion 42, and a coupling arrangement 50 coupled to the respective base portions 41, 42 such as to convert a rotation of the first base portion 41 about a first rotation axis Aᵣ₁ into a rotation of the second base portion 42 about a second rotation axis Aᵣ₂. The coupling arrangement 50 comprises N coupling portions 51 which are each coupled to the respective base portions 41, 42, at least in a tangential direction relative to the respective rotation axes Aᵣ₁, A₂, wherein N is at least two. The coupling portions 51 are mutually coupled such that the coupling portions 51 are displaceable relative to each other only in an axial direction of a central axis A_{c} which extends through center points Bₑ₁, Bₑ₂ of the respective base portions 41, 42.

1. Transmission system comprising:
a main housing;
a first base portion which is rotatable relative to the main housing about a first rotation axis which is stationary relative to the main housing;
a second base portion which is rotatable about a second rotation axis and pivotal about a pivot point which is stationary relative to the main housing, the second rotation axis maintaining a stationary orientation relative to the second base portion during pivoting of the second base portion about the pivot point;
a coupling arrangement coupled to the first base portion and to the second base portion such as to convert a rotation of the first base portion about the first rotation axis into a rotation of the second base portion about the second rotation axis; wherein:
the coupling arrangement comprises N coupling portions which are each coupled to the first base portion, at least in a tangential direction relative to the first rotation axis, in a respective one of N first coupling positions on the first base portion, and which are each coupled to the second base portion, at least in a tangential direction relative to the second rotation axis, in a respective one of N second coupling positions on the second base portion, wherein N is at least two;
the N first coupling positions have equal axial positions in a direction parallel to the first rotation axis, a first center point of the first base portion being located on the first rotation axis in a position corresponding to said axial positions of the N first coupling positions;
the N second coupling positions have equal axial positions in a direction parallel to the second rotation axis, a second center point of the second base portion being located on the second rotation axis in a position corresponding to said axial positions of the N second coupling positions;
a central axis of the coupling arrangement extends through the first and second center points; and
the coupling portions are mutually coupled such that the coupling portions are displaceable relative to each other only in an axial direction of the central axis.

2. Transmission system as claimed in claim 1, wherein the first rotation axis and the second rotation axis extend both through the pivot point.

3. Transmission system as claimed in claim 1, wherein the pivot point is arranged at a distance from an imaginary surface extending through the second center point perpendicularly to the second rotational axis, and wherein said imaginary surface is located between the pivot point and the first center point.

4. Transmission system as claimed in claim 1, wherein N is at least three, and wherein the N coupling portions are arranged at mutually identical angular intervals of 360°/N around the central axis.

5. Transmission system as claimed in claim 1, wherein the N coupling portions are mutually identical.

6. Transmission system according to claim 1, wherein the coupling portions of each pair of adjacent coupling portions are mutually coupled by means of a guiding structure that allows the coupling portions of the pair to mutually slide in the axial direction of the central axis.

7. Transmission system according to claim 1, wherein the coupling portions are each, in the respective first coupling position, displaceably guided relative to the first base portion in the direction parallel to the central axis, and/or wherein the coupling portions are each, in the respective second coupling position, displaceably guided relative to the second base portion in the direction parallel to the central axis.

8. Transmission system according to claim 7, wherein the coupling portions are each, in the respective first coupling position, coupled to the first base portion by means of a pin-slot connection comprising a pin mounted to the first base portion in the respective first coupling position and engaging a slot provided in the respective coupling portion and extending parallel to the central axis, and/or wherein the coupling portions are each, in the respective second coupling position, coupled to the second base portion by means of a pin-slot connection comprising a pin mounted to the second base portion in the respective second coupling position and engaging a slot provided in the respective coupling portion and extending parallel to the central axis.

9. Transmission system according to claim 1, wherein a gear wheel is connected to the second base portion at a side of the second base portion facing away from the coupling arrangement, and wherein a gear axis of the gear wheel coincides with the second rotation axis.

10. Shaving head of an electric shaver, comprising:
a support structure;
a shaving unit supporting at least two hair-cutting units which each have an external cutting member and an internal cutting member which is rotatable relative to the external cutting member; and
a transmission system according to claim 1;
wherein:
the main housing of the transmission system is arranged in a stationary position relative to the support structure;
the shaving unit, together with the hair-cutting units, is arranged to be allowed to assume pivoted positions relative to the support structure about a pivot point corresponding to the pivot point of the transmission system;
the first base portion of the transmission system is rotationally supported relative to the support structure of the shaving head; and
the second base portion of the transmission system is rotationally supported relative to the shaving unit of the shaving head.

11. Shaving head according to claim 10, further comprising a central drive shaft arranged in the support structure and a primary gearing system arranged in the shaving unit to convert a rotation of the central drive shaft into rotations of the internal cutting members of the respective hair-cutting units, wherein the coupling portions of the coupling arrangement of the transmission system are arranged around the central drive shaft.

12. Shaving head according to claim 10, comprising:
for each of the hair cutting units, a movable adjustment member;
a secondary gearing system arranged in the shaving unit to convert a rotation of the second base portion of the transmission system into movement of the adjustment member of each of the hair-cutting units.

13. Shaving head according to claim 12, wherein the transmission system is a transmission system, and wherein the gear wheel connected to the second base portion of the transmission system has a central position in the secondary gearing system.

14. Shaving head according to claim 12, wherein, in each of the hair-cutting units, the movable adjustment member is arranged to actuate a mechanism configured to adjust an operational parameter of the respective hair-cutting unit.

15. Electric shaver comprising a body unit and a shaving head according to claim 10, wherein the shaving head is couplable or coupled to the body unit, and wherein the body unit accommodates an actuator which is configured to rotate the first base portion of the transmission system in the coupled condition of the shaving head.
